(19) United States
(12) Patent Application Publication
(10) Pub. No.: US 2020/0056415 A1
(43) Pub. Date: Feb. 20, 2020

(54) ARTICULATED-ARM DRIVE

(71) Applicant: Marantec Antriebs- und Steuerungstechnik GmbH & Co. KG, Marienfeld (DE)

(72) Inventor: Wolfgang MITTERMEYER, Bad Aibling (DE)

(21) Appl. No.: 16/543,473

(22) Filed: Aug. 16, 2019

(30) Foreign Application Priority Data
Aug. 17, 2018 (DE) 10 2018 120 138.9

(51) Int. Cl. E05F 15/63

(52) U.S. Cl. CPC E05F 15/63; E05Y 2201/626; E05Y 2900/402; E05Y 2900/132

(57) ABSTRACT

The present disclosure relates to an articulated-arm drive, in particular for a swing gate, with a drive unit comprising an output shaft and an articulated arm, wherein the articulated arm comprises a first and a second articulated-arm member, which are rotatably connected to each other by means of a first rotary joint, wherein the first articulated-arm member is connected or connectable to a stationary first pivot point at the end facing away from the first rotary joint, and wherein the second articulated-arm member is rotatably connectable to a gate at the end facing away from the first rotary joint. In accordance with the disclosure, the end of the first articulated-arm member facing away from the first rotary joint is not connected to the output shaft and the output shaft is connected to one of the articulated-arm members via a coupling arm.

### CROSS-REFERENCE TO RELATED APPLICATIONS

This application claims priority under 35 U.S.C. § 119 to German Patent Application No. 10 2018 120 138.9, filed on Aug. 17, 2018, in the German Patent and Trade Mark Office, the disclosure of which is incorporated herein by reference in its entirety.

### TECHNICAL FIELD

The present disclosure relates to an articulated-arm drive, in particular for a swing gate.

### BACKGROUND AND SUMMARY

For automatically opening and closing swing gates various drive concepts are known. For example, swing gate drives are known in which a rod telescopically extends and retracts and hence moves the gate around a gate pivot point. The gate pivot point usually is attached to a stationary structure, for example a wall or a post. Depending on the distance and position of the gate pivot point to the post, such drives in part require protruding fittings. In the case of deep posts protruding into the interior space to be closed by the swing gate an assembly often is not possible at all.

Furthermore, swing gate drives are known which move the gate by means of an articulated arm. The same can also be mounted in the case of large, e.g. brick-built posts. At an open gate position, however, articulated-arm drives—due to their construction—require an additional working space for the joint of the rotary arms (elbows) on the side facing away from the gate. When an obstacle, e.g. a wall or the property boundary, is located beside the post, such articulated-arm drives cannot be used.

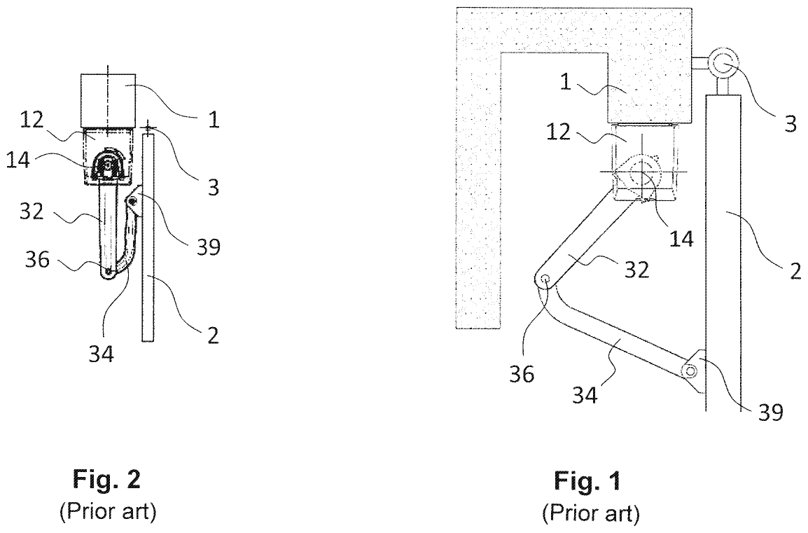

FIG. 1 shows an example for such an articulated-arm drive known from the prior art. The gate 2 is pivotable by 90° around a gate pivot point 3 attached to a stationary post 1 by means of the articulated-arm drive. The articulated arm, which is driven by a drive unit 12, consists of two arms 32, 34 which are rotatably connected to each other by a rotary joint 36. The gate-side arm 34 is articulated to the gate via a fitting 39, while the drive-side arm 32 is connected to an output shaft 14 of the drive unit 12. FIG. 1 shows the gate in a completely (90°) open position.

Due to the design of the articulated arm, the rotary joint 36 of the articulated arm during the opening movement moves towards the side facing away from the gate or into the interior space and therefore requires a certain working space so as not to collide with an obstacle (for example a wall). During the opening movement, the first arm 32 performs a rotary movement of more than 90°.

There are also known articulated-arm drives in which the second arm 34 articulated to the gate 2 is designed relatively short or adjustable in its length so that for opening the gate 2 the first arm 32 attached to the drive 12 only performs a rotary movement of about 90°. In the open position of the gate 2, the two articulated arms 32, 34 then are approximately parallel (see FIG. 2). This has the advantage that with confined installation conditions no additional working space is required.

However, the approximately parallel position of the rotary arms 32, 34 also has some disadvantages. On the one hand, the gate 2 is not stably held in its open position by the drive 12, as the rotary arms 32, 34 almost are in a dead-center position and can produce little force against a pivoting movement of the gate 2. On the other hand, the drive 12 must apply a very high force on closing of the gate 2, as the leverage correspondingly is unfavorable due to the approximately parallel rotary arms 32, 34.

Another disadvantage of such swing gate drives known from the prior art consists in that due to the comparatively small swivel angle of the drive-side arm the gate is opened relatively quickly, which makes a safe recognition of obstacles and a force cut-off difficult. Therefore, only comparatively small or lightweight gates can reliably be moved by drives comprising such articulated arms.

Therefore, it is the object of the present disclosure to provide an articulated-arm drive which also with confined space conditions provides for a reliable opening and closing of swing gates.

In accordance with the disclosure, this object is achieved by an articulated-arm drive. Accordingly, there is provided an articulated-arm drive which comprises a drive unit with an out-put shaft and an articulated arm, wherein the articulated arm includes a first and a second articulated-arm member, which are rotatably connected to each other by means of a first rotary joint. The first articulated-arm member is connected or connectable to a stationary first pivot point at the end facing away from the first rotary joint. The second articulated-arm member is rotatably connectable to a gate, in particular swing gate, at the end facing away from the first rotary joint.

In accordance with the disclosure it is provided that the end of the first articulated-arm member facing away from the first rotary joint is not connected to the output shaft and that the output shaft is connected to one of the articulated-arm members via a coupling element. The end of the first articulated-arm member facing away from the first rotary joint can be attached for example to a post, a rack, a wall or another stationary part, e.g. by means of a fitting.

By the arrangement according to the disclosure it is achieved that the gate can be opened without individual members of the joint mechanism requiring an additional working space in the region facing away from the gate or in the inner region of the space to be closed by the gate. This mechanism thereby is well suited in particular for confined installation situations. In addition, the articulated arm itself is held stably and safely by the coupling arm even at an approximately parallel position of the articulated-arm members.

Advantageous embodiments of the disclosure can be taken from the sub-claims and the following description.

In one embodiment it is provided that the coupling arm is rotatably connected to one of the articulated-arm members, the coupling arm hence is articulated to one of the transmission-arm members at a pivot point.

In another embodiment it is provided that the coupling arm is rotatably connected to the first articulated-arm member, the coupling arm hence is articulated to the first transmission-arm member at a pivot point.

In another embodiment it is provided that the coupling arm comprises a first and a second coupling-arm member, which are rotatably connected to each other by means of a second rotary joint, wherein at the end facing away from the second rotary joint the first coupling-arm member is connected, in particular non-rotatably connected to the output shaft, and wherein at the end facing away from the second rotary joint the second coupling-arm member is rotatably connected to an articulated-arm member at a second pivot point. Hence, the coupling arm here is configured as an articulated arm, in particular as a double joint, whereby a particularly space-saving and stable construction is obtained, which is advantageous with regard to the force to be applied by the drive unit.

In another embodiment it is provided that the articulated-arm drive has an open position, in which a gate connected to the second articulated-arm member is completely open, and a closed position, in which a gate connected to the second articulated-arm member is completely closed, wherein the coupling arm and the articulated arm are configured and connected to each other such that in the open position the coupling-arm members take on an acute angle and in the closed position an obtuse angle to each other at the second rotary joint.

Thus, the gate is safely held in both end positions due to the position of the coupling-arm members. When the gate is closed, the coupling-arm members are almost extended (obtuse angle close to, but less than 180°), and when the gate is open, they are almost parallel (acute angle close to, but greater than 0°).

Furthermore, with a favorable arrangement of the coupling-arm members the gate movement is slowed down towards both end positions (0° and 180°), as the coupling-arm members approach their corresponding dead-center positions, which protects the mechanism of the entire articulated-arm drive and the gate.

In addition, the coupling transmission as a whole acts like a speed-reducing ratio, optionally with a gear ratio i of about i=2. This means that the rotary movement of the first coupling-arm member is faster than, optionally almost twice as fast as the rotary movement of the first articulated-arm member. A rotary movement of the output shaft or of the first coupling-arm member by about 180° thereby leads to a gate opening of about 90°, whereby also relatively broad and heavy gates can safely be moved.

In another embodiment it is provided that the first and second coupling-arm members are shorter than the first articulated-arm member, optionally shorter than the first and second articulated-arm members. This results in a further saving of space and weight.

In another embodiment it is provided that the first and second coupling-arm members never take a dead-center position. The first coupling-arm member moves in an angle of rotation range of less than 180°. The angle between the two coupling-arm members at the second rotary joint hence in both end positions (open and closed position of the articulated-arm drive) reaches neither 0° nor 180°. Due to the fact that the dead-center positions (toggle lever effect) of the coupling-arm members are deliberately not reached, a good force cut-off and stability can be ensured.

In another embodiment it is provided that the coupling arm and the articulated arm are configured and connected to each other such that the articulated-arm members in the open position take on an acute angle and in the closed position an obtuse angle to each other at the first rotary joint.

In another embodiment it is provided that the first and second articulated-arm members never take a dead-center position. As already with the coupling-arm members, this provides the advantage that by avoiding the dead-center positions (toggle lever effect) a good force cut-off and stability can be ensured. Advantageously both in the coupling-arm members and in the articulated-arm members the respective dead-center positions are avoided.

In another embodiment it is provided that the first articulated-arm member and/or the second articulated-arm member is adjustable in its length. As a result, the articulated-arm drive can optimally be adapted to various installation situations in a quick and easy way. It can be provided that the first articulated-arm member and/or the second articulated-arm member is configured as a telescopic rod or telescopic cylinder. The length adjustment can be executable manually or automatically.

In another embodiment it is provided that the drive unit comprises a drive housing, wherein the stationary first pivot point is arranged on or in the drive housing. Mounting an additional fitting, to which the end of the first articulated-arm member facing away from the first rotary joint is articulated, thereby can be avoided.

### DETAILED DESCRIPTION

Further features, details and advantages of the disclosure can be taken from the exemplary embodiment explained with reference to the Figures, in which:

FIG. 1: shows a top view of an articulated-arm drive according to the prior art with a two-part articulated arm;

FIG. 2: shows a top view of another articulated-arm drive according to the prior art with a two-part articulated arm;

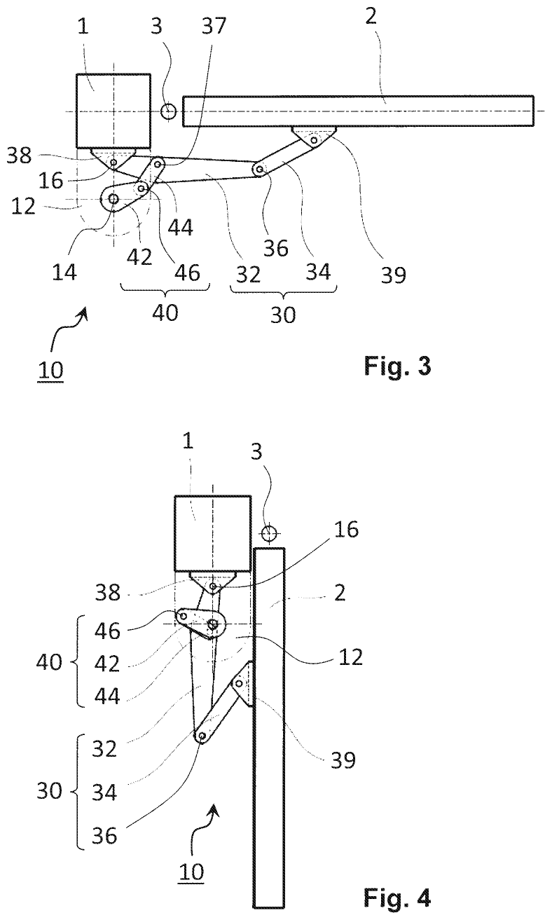

FIG. 3: shows a top view of an exemplary embodiment of the articulated-arm drive according to the disclosure when the gate is completely closed; and

FIG. 4: shows a top view of the exemplary embodiment of FIG. 3 when the gate is completely open.

FIGS. 1 and 2 show articulated-arm drives known from the prior art and have already been described in the introduction. A repetitive description therefore is omitted at this point.

FIGS. 3 and 4 show an exemplary embodiment of the articulated-arm drive 10 according to the disclosure in the two end positions of the gate 2 actuatable by the same, namely in the closed position in which the gate 2 is completely closed (FIG. 3) and in the open position in which the gate 2 is completely open (FIG. 4). In this exemplary embodiment, the gate 2 can be rotated by 90° or opened by the articulated-arm drive 10. The swing gate 2 movable by means of the articulated-arm drive 10 therefor is rotatably mounted on a stationary gate pivot point 3.

The articulated-arm drive 10 according to the disclosure comprises an articulated arm 30 which includes a first articulated-arm member 32 and a second articulated-arm member 34, which at their ends are rotatably connected to each other by means of a first rotary joint 36. The second articulated-arm member 34 is designed shorter than the first articulated-arm member 32. The other end of the second articulated-arm member 34 facing away from the first rotary joint 36 is articulated to the gate 2 via a gate-side fitting 39.

In contrast to drives known from the prior art, the other end of the first articulated-arm member 32 facing away from the first rotary joint 36 now is not connected to a drive unit, but is articulated to a stationary rack 1 via a stationary rack-side fitting 38. The rack 1 for example can be a gate post or a wall. The rack 1, the two articulated-arm members 32, 34 and the gate 2 form a four-bar linkage, wherein the first articulated-arm member 32 acts as rocker and the second articulated-arm member 34 as coupler.

The first articulated-arm member 32 of the articulated arm 30 is driven via a coupling arm 40 which is designed as a double stop. The coupling arm 40 includes a first coupling-arm member 42 and a second coupling-arm member 44, which at their ends are rotatably connected to each other by means of second rotary joint 46. The first coupling-arm member 42 acts as a crank and is connected to the output shaft 14 of a drive unit 12 of the articulated-arm drive 10 with the end that faces away from the second rotary joint 46. The second coupling-arm member 44 on the other hand acts as a coupler and with its end facing away from the second rotary joint 46 is articulated to the first articulated-arm member 32 via a pivot point 37. The pivot point 37 is located closer to the rack-side end of the first articulated-arm member 32 than to the first rotary joint 36. The coupling-arm members 42, 44 are shorter than the articulated-arm members 32, 34.

On actuation of the drive unit 12, the crank rotates along with the rotating output shaft 14, whereby the first articulated-arm member 32 is pivoted around the stationary pivot point 16. The gate 2 thereby is pivoted around the stationary gate pivot point 3.

In the closed position of the articulated-arm drive 10 (FIG. 3) the gate is completely closed. Both the articulated-arm members 32, 34 and the coupling-arm members 42, 44 are almost completely extended and include an angle of almost 180° to each other at the respective rotary joint 36, 46. However, the respective dead-center positions are not reached, in which the articulated-arm members 32, 34 and the coupling-arm members 42, 44 each would be aligned completely parallel and would take on an angle of 180°.

In the open position of the articulated-arm drive 10 (FIG. 4) the gate is completely open and the articulated-arm members 32, 34 include an acute angle to each other at the first rotary joint 36. The coupling-arm members 42, 44 are folded in almost completely parallel and at the second rotary joint 46 include a small acute angle to each other. Here as well, the respective dead-center positions are not reached entirely, in which the articulated-arm members 32, 34 and the coupling-arm members 42, 44 each would be aligned completely parallel and would take on an angle of 0°.

By deliberately avoiding that the dead-center positions of the articulated-arm members 32, 34 and of the coupling-arm members 42, 44 are reached in the respective end positions (open position and closed position), a good force cut-off and a high stability are ensured.

Due to the inventive configuration of the articulated-arm drive 10, the gate movement is slowed down towards both end positions, as the coupling-arm members 42, 44 approach their corresponding dead-center positions (but do not reach the same completely, as explained already). This protects the mechanism of the articulated-arm drive 10 (drive, joints, gate, etc.).

In addition, the drive by means of the coupling arm 40 as a whole acts like a speed-reducing ratio with a gear ratio i of about i=2. This means that the rotary movement of the first coupling-arm member 42 substantially is twice as fast as the rotary movement of the first articulated-arm member 32. A rotary movement of the output shaft 14 or of the first coupling-arm member 42 by about 180° thereby leads to a gate opening of about 90°, whereby also relatively broad and heavy gates can safely and stably be moved.

Due to the arrangement according to the disclosure, the transmission members 32, 34, 42, 44 of the articulated-arm drive 10 move more closely to the door 2 as compared to the remaining articulated-arm drives and therefore protrude less far into the free space. This applies in particular when the gate 2 is open (open position), whereby the articulated-arm drive 10 according to the disclosure is excellently suited for confined installation situations.

In addition, the articulated arm 30 always is stably held by the coupling arm 40, in particular in the end positions. As the coupling arm 40 always has a certain angle to the driven first articulated-arm member 32, good and stable force conditions exist at any time, in particular in the end positions.

### LIST OF REFERENCE NUMERALS

1 rack
2 gate
3 gate pivot point
10 articulated-arm drive
12 drive unit
14 output shaft
16 stationary pivot point
30 articulated arm
32 first articulated-arm member (rocker)
34 second articulated-arm member (coupler)
36 first rotary joint
37 pivot point crank/rocker
38 rack-side fitting
39 gate-side fitting
40 coupling arm
42 first coupling-arm member (crank)
44 second coupling-arm member (coupler)
46 second rotary joint

1. An articulated-arm drive with a drive unit comprising an output shaft and an articulated arm, wherein the articulated arm comprises a first and a second articulated-arm member, which are rotatably connected to each other by means of a first rotary joint, wherein the first articulated-arm member is connected or connectable to a stationary pivot point at an end facing away from the first rotary joint and wherein the second articulated-arm member is rotatably connectable to a gate at the end facing away from the first rotary joint, wherein the end of the first articulated-arm member facing away from the first rotary joint is not connected to the output shaft and that the output shaft is connected to one of the articulated-arm members via a coupling arm.

2. The articulated-arm drive according to claim 1, wherein the coupling arm is rotatably connected to the first articulated-arm member.

3. The articulated-arm drive according to claim 1, wherein the coupling arm comprises a first and a second coupling-arm member, which are rotatably connected to each other by means of a second rotary joint, wherein at an end facing away from the second rotary joint the first coupling-arm member is connected, and wherein at the end facing away from the second rotary joint the second coupling-arm member is rotatably connected to an articulated-arm member at a second pivot point.

4. The articulated-arm drive according to claim 3, wherein the first and second coupling-arm members are shorter than the first articulated-arm member.

5. The articulated-arm drive according to claim 3, wherein the articulated-arm drive has an open position in which a gate connected to the second articulated-arm member is completely open, and a closed position in which a gate connected to the second articulated-arm member is completely closed, wherein the coupling arm and the articulated arm are configured and connected to each other such that in the open position the coupling-arm members take on an acute angle and in the closed position an obtuse angle to each other at the second rotary joint.

6. The articulated-arm drive according to claim 3, wherein the first and second coupling-arm members never take a dead-center position.

7. The articulated-arm drive according to claim 1, wherein the articulated-arm drive has an open position in which a gate connected to the second articulated-arm member is completely open, and a closed position in which a gate connected to the second articulated-arm member is completely closed, wherein the coupling arm and the articulated arm are configured and connected to each other such that in the open position the articulated-arm members take on an acute angle and in the closed position an obtuse angle to each other at the first rotary joint.

8. The articulated-arm drive according to claim 1, wherein the first and second articulated-arm members never take a dead-center position.

9. The articulated-arm drive according to claim 1, wherein the first articulated-arm member and/or the second articulated-arm member is adjustable in its length.

10. The articulated-arm drive according to claim 1, wherein the drive unit comprises a drive housing, wherein the stationary pivot point is arranged on or in the drive housing.

11. The articulated arm-drive according to claim 3, wherein the first coupling-arm member is non-rotatably connected to the output shaft.

12. The articulated-arm drive according to claim 4, wherein the first and second coupling-arm members are shorter than the first and second articulated-arm members.

13. The articulated-arm drive according to claim 5, wherein the first and second coupling-arm members never take a dead-center position.

14. The articulated-arm drive according to claim 2, wherein the coupling arm comprises a first and a second coupling-arm member, which are rotatably connected to each other by means of a second rotary joint, wherein at an end facing away from the second rotary joint the first coupling-arm member is connected, and wherein at the end facing away from the second rotary joint the second coupling-arm member is rotatably connected to an articulated-arm member at a second pivot point.

15. The articulated-arm drive according to claim 14, wherein the first coupling-arm member is non-rotatably connected to the output shaft.
